(19) United States
(12) Patent Application Publication
(10) Pub. No.: US 2002/0040340 A1
(43) Pub. Date: Apr. 4, 2002

(54) Apparatus and method for supporting transactions

(76) Inventor: Hidefumi Yoshida, Kawasaki (JP)

Correspondence Address: STAAS & HALSEY LLP, 700 11TH STREET, NW, SUITE 500, WASHINGTON, DC, 20001, US

(21) Appl. No.: 09/804,039

(22) Filed: Mar. 13, 2001

(30) Foreign Application Priority Data
Sep. 22, 2000 (JP) 2000-288204

(51) Int. Cl. G06F 17/60

(52) U.S. Cl. 705/39

(57) ABSTRACT

There is provided a transaction supporting apparatus that supports safe and sure payment of a transaction that is made via the Internet. A buyer client accesses a seller server to purchases a product and make payment of the product via the transaction supporting apparatus. A transaction-detail registering unit of the apparatus registers the details of the transaction. A payment information notifying unit refers to the details of the transaction registered and notifies, via an e-mail, the buyer client of an account to which payment should be made and a deadline for such payment. If the buyer has not made payment to the account by the deadline, a charging unit accesses a bank server and acknowledges this situation. Then, the charging unit accesses a server of a credit card company and charges for the transaction in the name of the buyer.

### BACKGROUND OF THE INVENTION

1. Field of the Invention

The present invention relates to an apparatus and a method for supporting transactions, and more particularly to an apparatus and a method for supporting making payment of a transaction.

2. Description of the Related Art

The Internet has come into wide use and has stimulated the general customers to participate in shopping on the Internet.

Payment for a product purchased by the Internet shopping may be made by any of the following ways: (1) a transfer or remittance of an amount into a bank account, (2) payment in cash in exchange for a product, (3) settlement using a payment card such as a credit card, and (4) payment at a convenience store.

However, these ways to make payment have the following disadvantages.

(1) The way to transfer or remit an amount into a bank account principally requires payment in advance of receiving a purchased product. That is, the purchased product has not been delivered nevertheless payment must be made to an unknown trader. This would bear on the consumers.

(2) The way to make payment in cash in exchange for a product requires increased service fees because payment is made a home-delivery service agent. This increases the transaction fee.

(3) The way to make payment by card allows the user to easily settle with a creditor by entering his or her card number on the homepage. In contrast, there is a possibility that information on individual privacy may leak. Further, the service fees would be higher than those charged for transfer into bank accounts.

(4) The way to make payment at a convenience store causes the customer to go to the closest convenience store to receive the purchased produce. If the product were heavy or bulky, the customer would not feel comfortable.

As described above, the conventional ways to make payment have the problems.

### SUMMARY OF THE INVENTION

Taking the above into consideration, an object of the present invention is to provide an apparatus and a method for supporting transactions, particularly safe and sure payment of a transaction that is made via a network such as the Internet.

1. To accomplish the above object, according to the present invention, there is provided a transaction supporting apparatus supporting making payment of a transaction including: transaction-detail registering means for registering details of a transaction; payment information notifying means for notifying a buyer of payment information; payment confirming means for confirming whether payment of the transaction has been made to an account specified in the payment information by a deadline also specified in the payment information; and charging means for charging for the transaction via a credit card when the payment confirming means confirms that the payment has not been made by the deadline.

To accomplish the above object, according to the present invention, there is also provided a method of supporting making payment of a transaction including the steps of: registering details of a transaction; notifying a buyer of payment information; confirming whether payment of the transaction has been made to an account specified in the payment information by a deadline also specified in the payment information; and charging for the transaction via a credit card when it is confirmed that the payment has not been made by the deadline.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a schematic diagram of a system including a transaction supporting apparatus of the present invention;

FIG. 2 is a diagram of an embodiment of the present invention;

FIG. 3 illustrates an example of a screen that is displayed when a product is purchased from a seller server and a way to make payment is chosen;

FIG. 4 illustrates an example of an e-mail that is sent to a buyer client by the transaction supporting apparatus in order to confirm the details of a transaction;

FIG. 5 illustrates an example of a screen displayed at the buyer client when a URL in the e-mail shown in FIG. 4 is clicked in a case where the details of the transaction are correct;

FIG. 6 illustrates an example of a screen that is displayed subsequent to the screen shown in FIG. 5 and is used to specify membership or non-membership;

FIG. 7 illustrates an example of a screen that is displayed when the non-membership is clicked on the screen shown in FIG. 6 and is used to register membership;

FIG. 8 illustrates an example of a screen displayed when the membership registration has been made on the screen shown in FIG. 7;

FIG. 9 illustrates an example of an e-mail that is sent to the buyer client by the transaction supporting apparatus after the screen shown in FIG. 8 is displayed and includes a bank account to which payment is made and a deadline for payment;

FIG. 10 illustrates an example of a screen displayed at terminal equipment owned by a delivery person of a home-delivery service agent;

FIG. 11 illustrates an example of an e-mail that is sent to the buyer client by the transaction supporting apparatus when the outstanding payment is overdue;

FIG. 12 illustrates an example of a screen that is displayed when the membership is chosen and is used to enter a membership number and a password;

FIG. 13 illustrates an example of a screen that notifies the buyer of the membership number and password;

FIG. 14 illustrates an example of a screen displayed after entry of the membership number and the password on the screen shown in FIG. 12;

FIG. 15 illustrates an example of a display that appears when the purchased product should be delivered to a place different from the registered address;

FIG. 16 is a flowchart of an example of a process that is executed by the transaction supporting apparatus when a request for intermediary service made by the seller server is received;

FIG. 17 is a flowchart of an example of a process that is executed when a URL attached to a transaction-detail confirmation mail is clicked;

FIG. 18 is a flowchart of an example of a process that is executed when the transaction supporting apparatus requests a home-delivery service agent to deliver the purchased product;

FIG. 19 is a flowchart of an example of a process that is executed when a credit card number is forwarded from terminal equipment of a delivery person via a server of the home-delivery service agent at the time of first utilization; and

FIG. 20 is a flowchart of an example of a process executed when the transaction supporting apparatus confirms that payment of the transaction has been made.

### DESCRIPTION OF THE PREFERRED EMBODIMENTS

Preferred embodiments of the present invention will be described below with reference to the accompanying drawings.

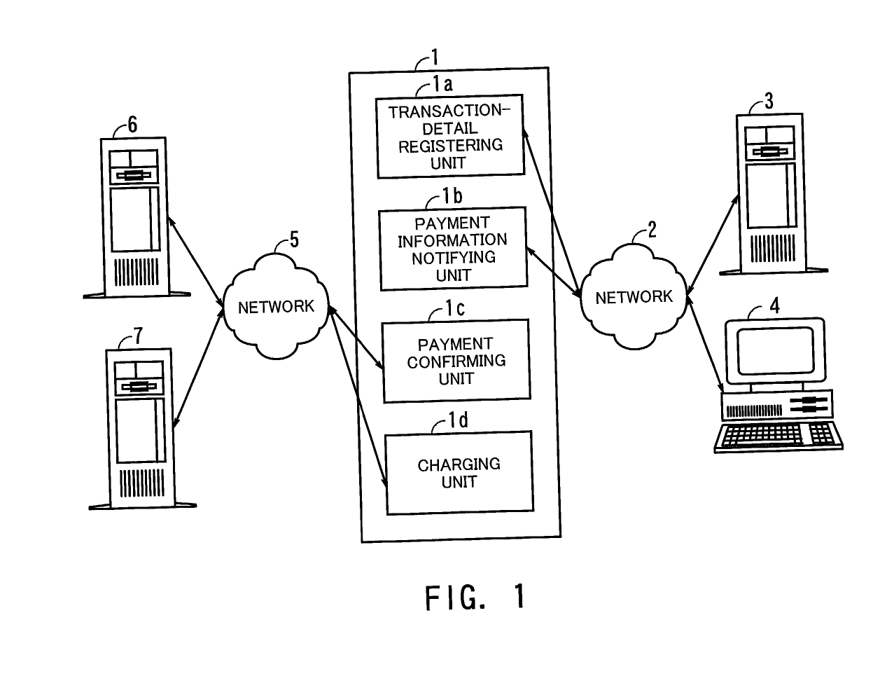

FIG. 1 is a schematic diagram of a system including a transaction supporting apparatus 1 of the present invention. The transaction supporting apparatus 1 is connected to a seller server 3 and a buyer client 4 via a network 2, and to a server 6 of a bank and a server 7 of a credit card company via a network 5.

The transaction supporting apparatus 1 is made up of a transaction-detail registering unit 1a, a payment information notifying unit 1b, a payment confirming unit 1c, and a charging unit 1d.

The transaction-detail registering unit 1a registers the detail of a transaction with which a buyer and a seller has agreed. The payment information notifying unit 1b notifies the buyer of payment information about payment of the transaction. The payment confirming unit 1c confirms whether payment has been made to a bank account specified in the payment information by a deadline also specified in the payment information. The charging unit 1d charges for the transaction via a credit card if the payment confirming unit 1c confirms that the payment has been made by the deadline.

The transaction supporting apparatus shown in FIG. 1 operates as follows.

It is assumed that a buyer operates the client 4 to have access to the server 3 of a seller and take the necessary steps to purchase a product, and specifies a way to make payment via the transaction supporting apparatus 1. Then, the server 3 sends to the transaction supporting apparatus the details of the transaction with which the buyer and the seller have agreed.

The transaction-detail registering unit 1a of the transaction supporting apparatus 1 receives the details of the transaction and registers therein. Then, the payment information notifying unit 1b refers to the details of the transaction and produces payment information containing a bank account to which payment should be made and a deadline for payment making. Then, the payment information notifying unit 1b delivers the payment information to the buyer client 4 via an e-mail or the like.

The buyer receives the e-mail and recognizes the bank account and deadline for payment therefrom. If the buyer agrees with the conditions for purchasing, the buyer has access to the transaction supporting apparatus 1 and shows, on a given homepage, that the buyer has agreed with the conditions. Then, the seller is informed that the buyer has agreed with the conditions, and ships the product to the buyer. At this time, an intermediary agent may charge an intermediary service fee.

The payment confirming unit 1c periodically accesses the bank server 6 to confirm whether payment of the purchased product has been made by the given deadline. If payment has duly been made by the given deadline, the payment confirming unit 1c accesses the bank server 6 again, and remits an amount calculated by subtracting the intermediary service fee from the paid amount to the account of the seller.

In the above description, the intermediary agent manages the bank account to which payment should be made. Alternatively, payment may be made to a bank account of the seller. In this alternative, the seller is required to notify the intermediary agent that payment has been made or not, or the intermediary agent is required to check payment made to the account of the seller. An intermediary service fee may be charged to the seller when agreement with the use of intermediary service has been made. It may also be possible to collect the intermediary service fees every month.

If the payment has not been made by the deadline, the payment confirming unit 1c sends a reminder message, a reminder mail or a reminder e-mail to the buyer client 4. Even if payment has not yet been made, the charging unit 1d has access to the server 7 of the credit card company to notify the credit card company of the details of the involved transaction in the name of the seller or the intermediary agent together with the buyer as necessary. Then, the charging unit 1d actually charges for the price of the purchased product (which additionally includes a service fee to be paid to the credit card company). Then, the charging unit 1d accesses the bank server 6 to remit to the bank account of the seller an amount calculated by subtracting its own service fee or the service fee for the intermediary service agent from the amount that has been paid by the transaction supporting apparatus 1.

According to the above-mentioned method, if the buyer chooses the way to make payment utilizing the transaction supporting apparatus 1, the credit card is mortgaged for an outstanding account. This allows the product to be immediately delivered to the buyer. The buyer can make payment of the purchased product via remittance to the seller's account with a comparatively low commission to be paid to the involved bank. Even if the buyer makes payment, the buyer is charged via the credit card. Thus, the seller can surely collect the price of the sold product.

A description will now be given of an embodiment of the present invention.

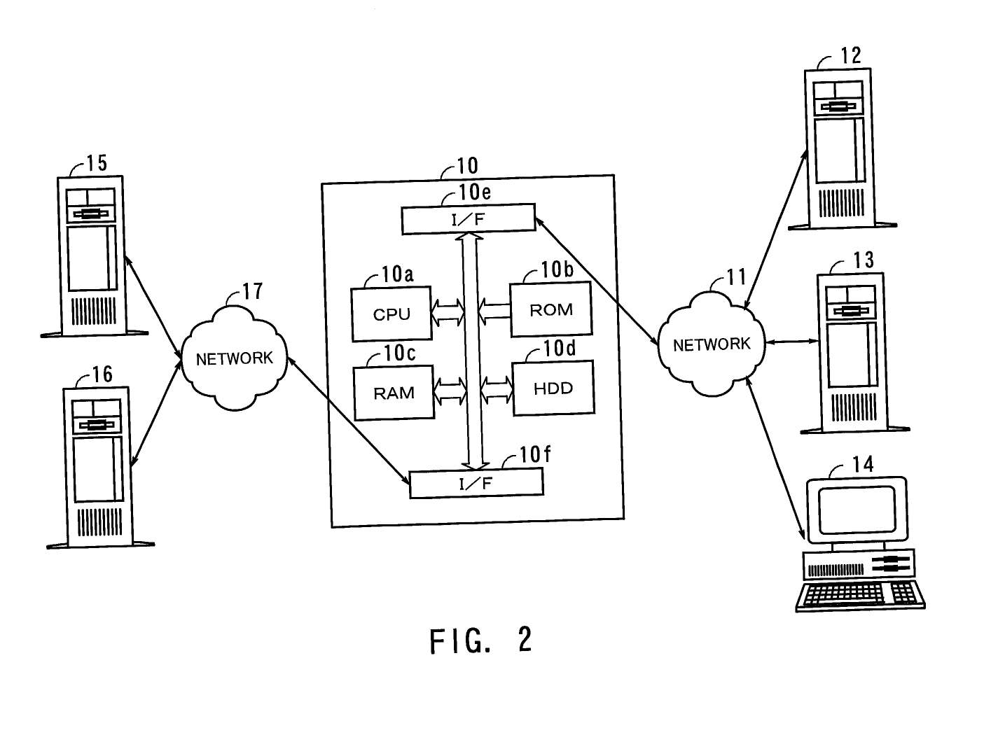

FIG. 2 is a diagram of an embodiment of the present invention. A transaction supporting apparatus 10 according to this embodiment is connected via a network 11 to a server 12 of a seller, a server 13 of a home-delivery service agent, and a server 14 of a buyer. The apparatus 10 is also connected via a network 17 to a server 15 of a bank and a server 16 of a credit card company.

The transaction supporting apparatus 10 is made up of a CPU (Central Processing Unit) 10a, a ROM (Read Only Memory) 10b, a RAM (Random Access Memory) 10c, an HDD (Hard Disk Drive) 10d, and I/F (InterFace) units 10e and 10f.

The CPU 10a executes various operational processes to control the other components in accordance with programs stored in the HDD 10d. The ROM 10b stores basic programs to be executed and data to be processed by the CPU 10a. The RAM 10c stores a program currently being executed by the CPU 10a and temporarily stores data being processed therein. The HDD 10d stores other programs to be executed by the CPU 10a and information about transactions. The I/F unit 10e performs data format conversions and protocol conversions when the transaction supporting apparatus 10 sends and receives, via the network 11, information to and from any of the seller server 12, the server 13 of the home-delivery service agent and the buyer client 4. The I/F unit 10f performs data format conversions and protocol conversions when the transaction supporting apparatus 10 sends and receives, via the network 17, information to and from the server 15 of the bank or the server 16 of the credit card company.

The network 11 may, for example, be the Internet. The network 17 may, for example, be the Internet or a dedicated line. The servers 12, 13, 15 and 16 may, for example, be workstations or server machines. The client 14 of the buyer may, for example, be personal computer.

Operation of the embodiment is described immediately below.

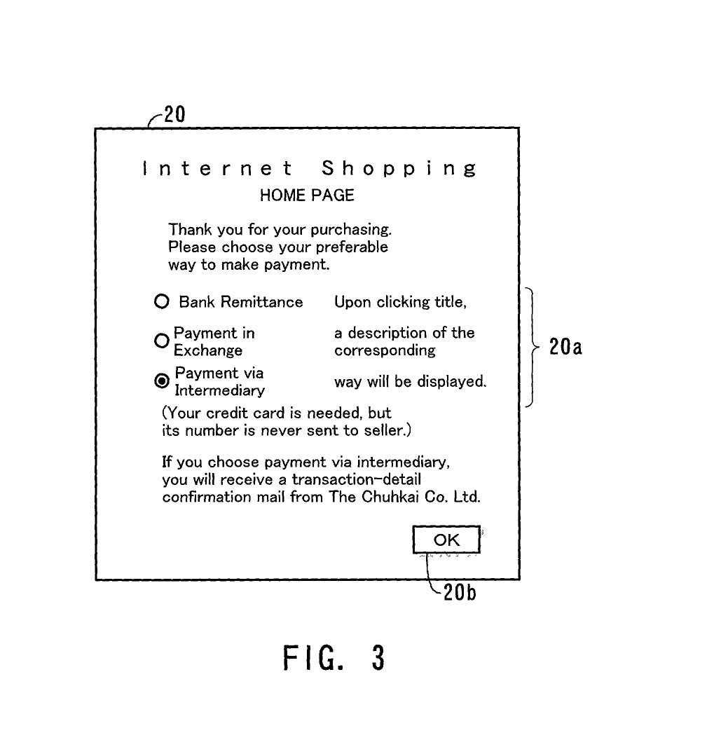

A user operates the buyer client 14 to have access to a shopping page that is set up on the seller server 12 and performs an operation for purchasing a product. This results in a payment making screen 20 shown in FIG. 3. In this example, one of the following three ways to make payment can be chosen on an area 20a of the payment making screen 20: “bank remittance”, “payment in exchange” and “payment via intermediary”. It is assumed that the user (buyer) chooses “payment via intermediary” in which payment of the purchased product is made via the transaction supporting apparatus 10, and then presses an “OK” button 20b. This results in transmission of the details of the transaction (the purchased product(s), the amount thereof, and the e-mail address of the buyer) to the transaction supporting apparatus 10.

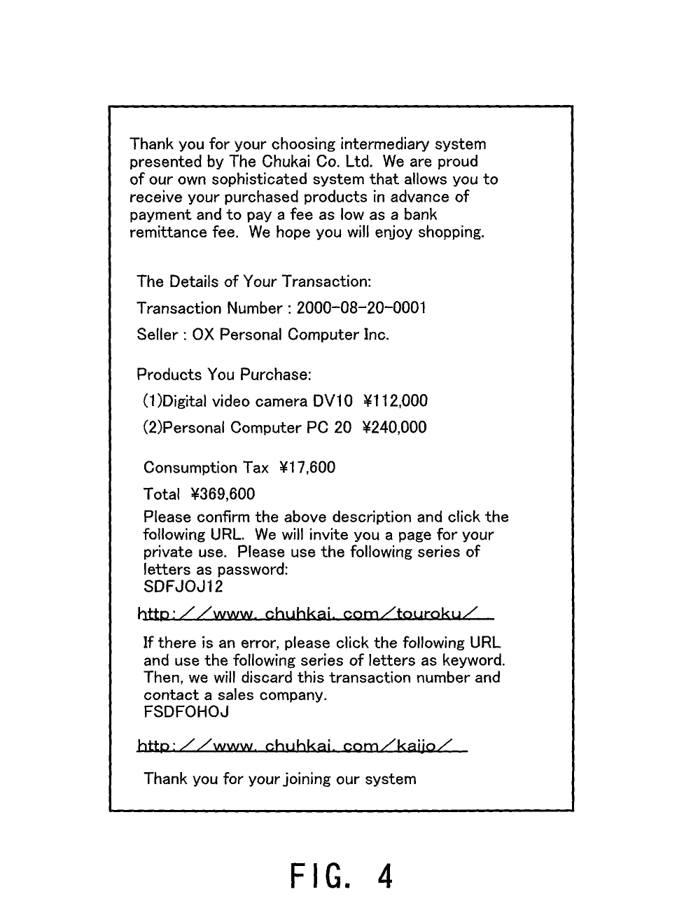

The transaction supporting apparatus 10 is notified of the details of the transaction via the I/F unit 10e, and generates a transaction number that serves as an identification number. Then, the apparatus 10 stores information about the details of the transaction in the HDD 10d in association with the transaction number. Thereafter, the apparatus 10 creates an e-mail as shown in FIG. 4 and sends it to the buyer.

This e-mail shows an acknowledgement of utilization of service provided by “The Chuhkai Co., Ltd. which owns the transaction supporting apparatus 10 and information showing the details of the transaction. The transaction-detail information described in the e-mail contains the transaction number (2000-08-20-0001) previously generated, the name of the seller (OX Personal Computer Inc.), the names of purchased products (digital video camera DV10, personal computer PC20), and a payment amount (¥369,600).

A message appears on the e-mail which urges the user to click URL “http://www.chuhkai.com/touroku/” if the description of the transaction is correct and click URL “http://www.chuhkai.com/kaijo/” if not.

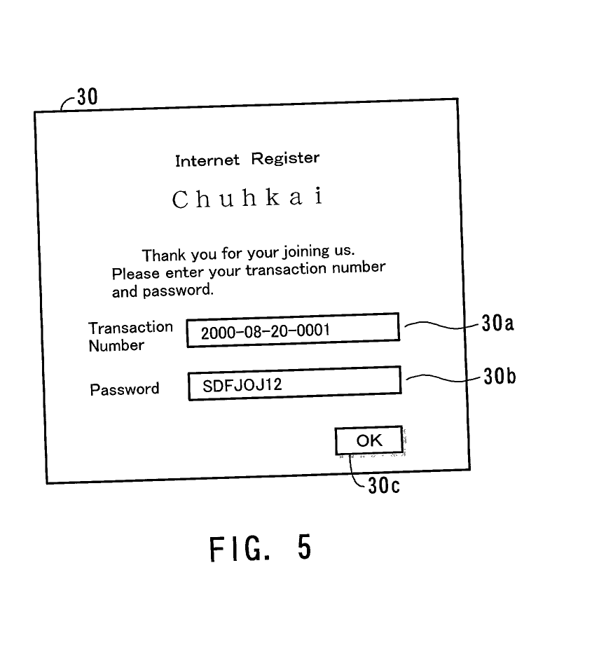

If the description of the transaction is correct, the buyer clicks URL “http://www.chuhkai.com/touroku/”, a browser installed in the buyer client 14 is initiated and the clicked URL is accessed. This URL indicates a homepage set up on the transaction supporting apparatus 10. When the page is downloaded, a screen 30 as shown in FIG. 5 appears at the buyer client 14.

In this example, the screen 30 shows a message that urges the buyer to enter a transaction number and a password, and shows text boxes 30a and 30b for entry thereof. The user enters, on the screen 30, the transaction number (2000-08-20-0001) and password (SDFJOJ12) contained in the received e-mail, and presses an “OK” button 30c. Then, the CPU 10a of the transaction supporting apparatus 10 acquires these items of information, and collates them with the information stored in the HDD 10d to thus identify objective information (the details of the transaction previously registered). It is possible to set up a URL which does not require entry of the transaction number.

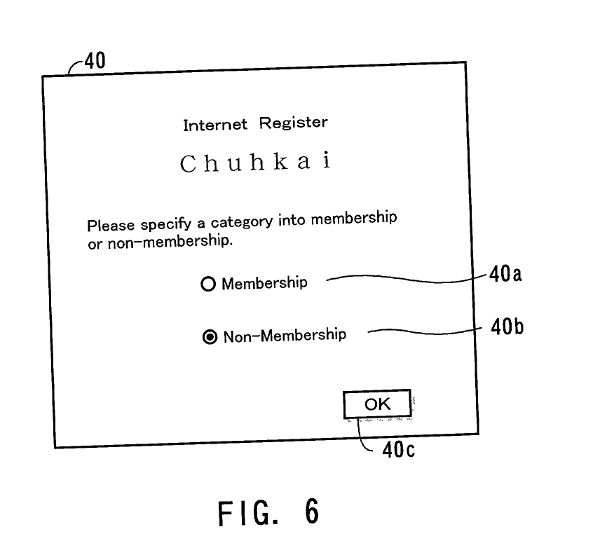

Then, the transaction supporting apparatus 10 causes a screen 40 as shown in FIG. 6 to be displayed at the buyer client 14. The buyer clicks a radio button 40a if he or she is a member of the intermediary service and clicks a radio button 40b if he or she is not a member thereof.

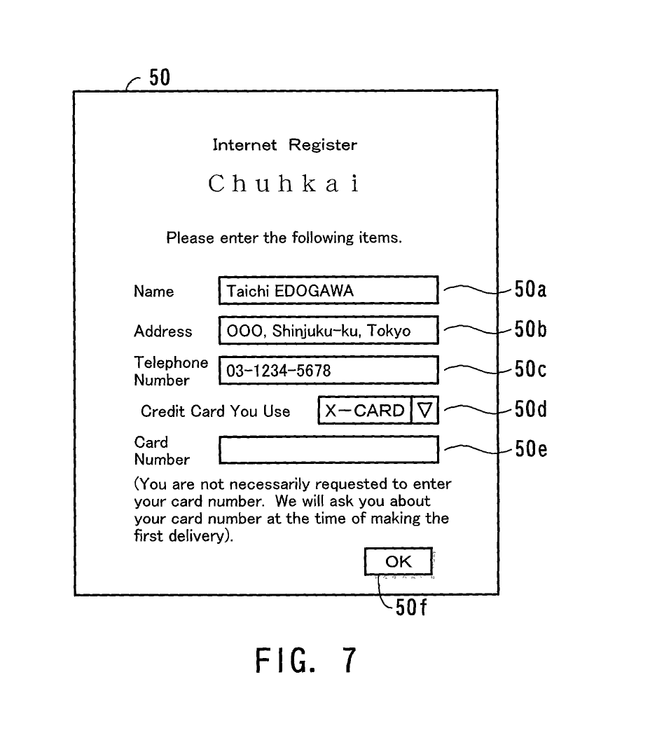

If the buyer is not a member, he or she clicks the radio button 40b and then presses an “OK” button 40c. This causes a screen 50 as shown in FIG. 7 to be displayed at the buyer client 14. In this example, the screen 50 has text boxes 50a through 50e for inputting items necessary to register membership. The text box 50a is used to enter the name of the buyer. The test box 50b is used to enter the address of the buyer. The text box 50c is used to enter the telephone number of the buyer. The text box 50d is used to enter the name of a credit card to be used. The text box 50e is used for entering the number of the credit card. If the buyer does not own any credit card, a message showing unavailability of intermediary service is shown. This situation would be avoided by explicitly describing the necessity of a credit card.

When the necessary items are input and an “OK”button 50f is pressed on the screen 50, the CPU 10a acquires the necessary items and registers the entry of membership in the HDD 10d.

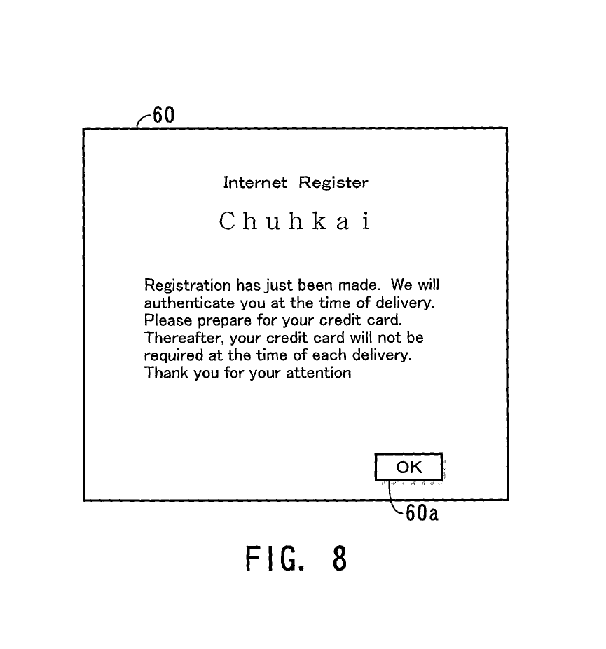

After completion of making membership registration, the transaction supporting apparatus 10 causes a screen 60 as shown in FIG. 8 to be displayed at the buyer client 14. In this example, the screen 60 shows that registration has been completed, and authentication with the credit card will be required when the purchased products are delivered to the buyer but will not be required for each transaction except the transaction that has been performed for the first time. The contents of the screen 60 remind the buyer to present the credit card when receiving the products.

Next, the transaction supporting apparatus 10 notifies the seller server 12 of approval of the transaction and normal completion of membership registration. Thus, the seller server 12 notifies the transaction supporting apparatus 10 of an expected delivery date.

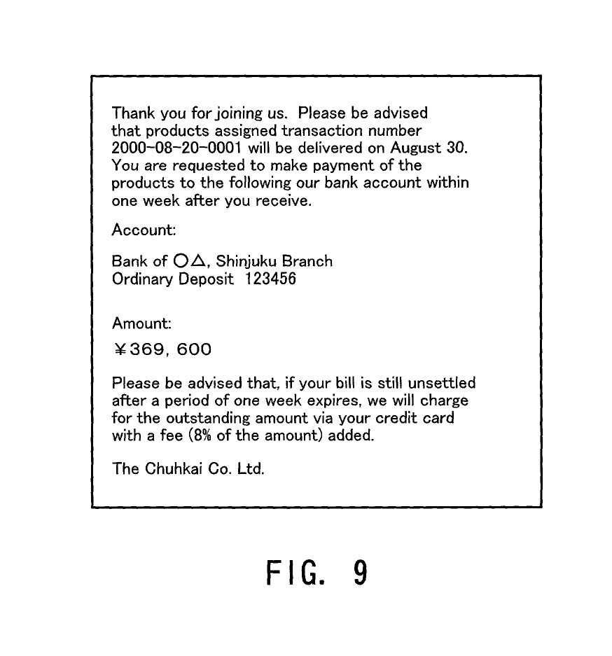

Then, the transaction supporting apparatus 10 creates an e-mail as shown in FIG. 9, and sends it to the buyer client 4. This e-mail shows the expected delivery date of products, the deadline for payment, and the bank account, and a message showing that payment of the account will be made via the credit card due to failure of remittance to the specified bank account.

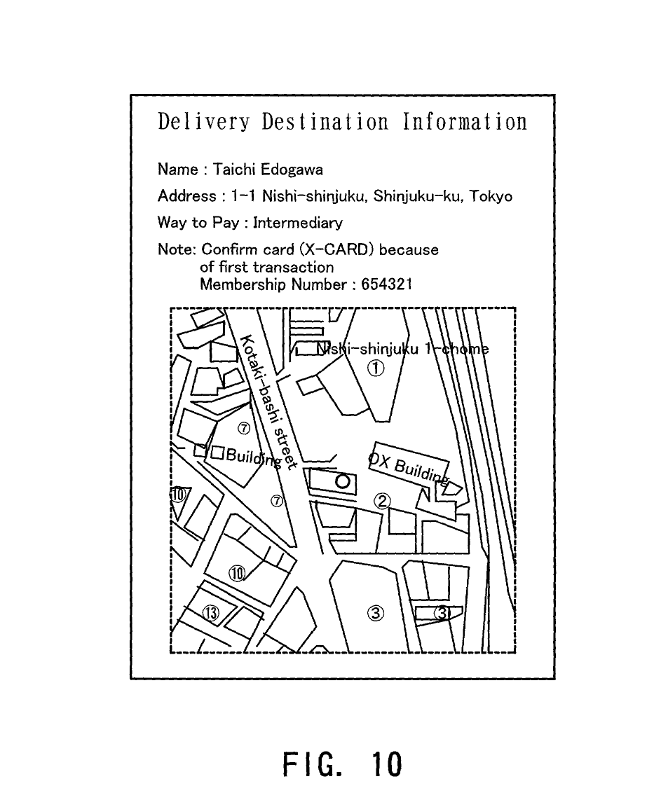

Thereafter, the transaction supporting apparatus 10 requests the server 13 of the home-delivery service agent to deliver the products and authenticate the credit card. In addition, the apparatus 10 sends the server 13 information about the buyer. The information about the buyer is transmitted, via the server 13 of the home delivery service agent, to terminal equipment owned by a delivery person. A screen as shown in FIG. 10 is displayed at the terminal equipment.

In this example, the screen shown in FIG. 10 shows information about the delivery destination. The information includes the name of the buyer (Taichi EDOGAWA), his or her address (1-1 Nishi-shinjuku, Shinjuku-ku, Tokyo, Japan), the way to make payment (intermediary) and a message showing that this is the first transaction that requires authentication of the credit card (X-CARD) that needs a membership number “654321”.

The information displayed on the screen facilitates delivery of the products to the buyer and enables sure authentication by the delivery person. In the authentication, the delivery person obtains the card number of the credit card from the buyer and enters it in the terminal equipment. The card number is encrypted in the terminal equipment and is then sent to the server 13 of the home-delivery service agent. The server 13 transfers the encrypted card number to the transaction supporting apparatus 10. Then the apparatus 10 decrypts the encrypted card number and registers it in association with the membership information about the buyer. It is required to obtain the card number from the buyer at the time of making the first delivery. This requirement would need a reliable agent. Thus, it is preferable that a reliable agent is selected and entrusted with the first-time delivery. An agent that is advantageous in terms of delivery service area and fee may be selectively entrusted with each delivery after the first delivery.

As described in the e-main shown in FIG. 9, the buyer which has received the products is requested to remit the amount to the specified bank account within a specified period which may, for example, be one week. If the payment has been made within the specified period, the transaction supporting apparatus 10 detects the payment in periodical access to the bank server 15, and acknowledges the completion of payment. Then, the transaction supporting apparatus 10 accesses the bank server 15 again and remits the amount obtained by subtracting its own fee from the amount that has been remitted to the account of the buyer.

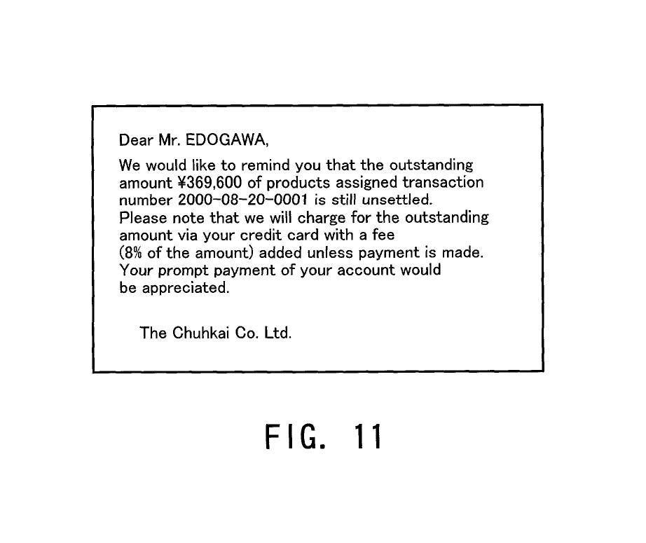

If the payment has not been made within the specified period, namely, if the account of the buyer does not have a balance sufficient to the payment to be made by the buyer, the transaction supporting apparatus 10 acknowledges this situation and creates a reminder as shown in FIG. 11 and sends it to the buyer. In this example, the reminder shows that the payment of the products has not been made and will be made via the credit card with a fee added thereto unless prompt payment is made.

If the buyer who has received the above reminder remits the amount to the specified account within the specified period, the same process as described above will be performed so that the payment is completed.

In contrast, if the buyer does not make payment although receiving the reminder, the transaction supporting apparatus 10 accesses the server 16 of the credit card company to inform it of the details of the transaction in the name of the seller or the intermediary agent together with the buyer as necessary and to charge for the transaction via the credit card. In advance of settlement via the credit card, the buyer may be notified, via an e-mail, telephone or a letter, that the account will be settled via the credit card.

As described above, when the payment is made for the first time via the transaction supporting apparatus 10, the home-delivery service agent authenticates a person who receives the delivered products, and directly asks him or her about the card number of his or her credit card. This allows the buyer to make payment of the products upon actual receipt and avoids notifying an unknown agent of his or her card number. Thus, the buyer would purchase products with security. Also, the seller would sell products with security because the home-delivery service agent passes the products to the buyer after individual authentication and also the credit card is mortgaged.

The above description is directed to the situation in which the payment is made via the transaction supporting apparatus 10 for the first time. On and after the second-time payment, the following process is executed. In the following, the same process as that which has been described will be omitted for the sake of simplicity.

The processes shown in FIGS. 3 through 5 will also be executed in each transaction via the transaction supporting apparatus 10 after the first transaction.

In FIG. 6, the membership registration has been made at the time of the first utilization of the transaction supporting apparatus 10. Therefore, the radio button 40a is selected and the “OK” button 40c is pressed. This results in a screen 70 displayed at the buyer client 14, on which boxes 70a and 70b respectively used for entry of the membership number of the buyer and his or her password appear. The transaction supporting apparatus 10 may automatically generate the membership number and the password, which are sent to the buyer via an e-mail or a letter.

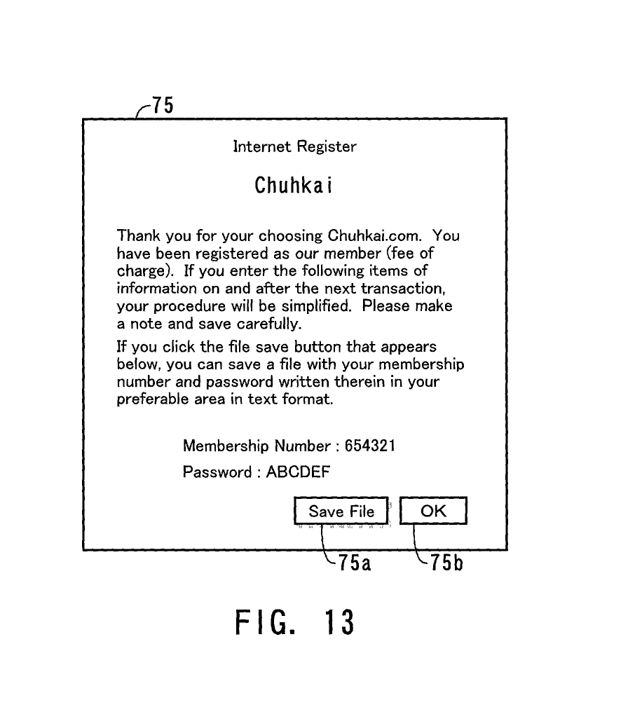

FIG. 13 illustrates an example of a screen 75 displayed at the buyer client 14. In this example, a message appears on the screen 75 showing that the membership registration has been made and the membership number and password can be saved by pressing a file save button 75a. When the file save button 75a is pressed on the screen 75, the membership number and the password are saved in a given storage area. In contrast, pressing of an “OK” button 75b ends the process without saving.

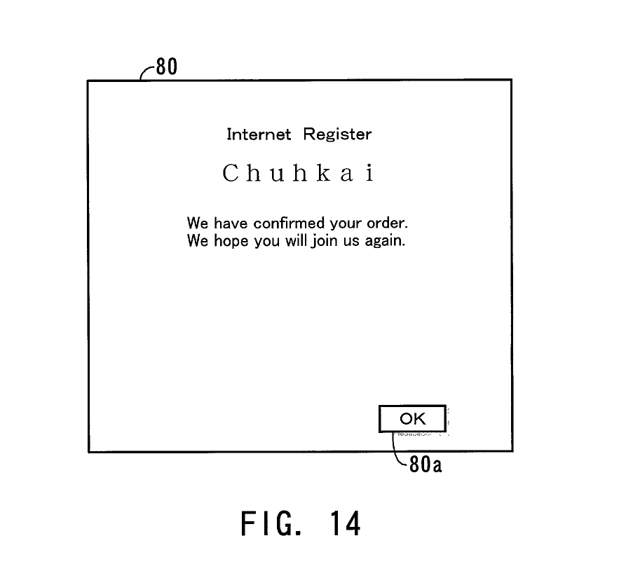

If the buyer enters his or her membership number and password and presses an “OK” button 70c, the buyer client 14 encrypts these items and sends them to the transaction supporting apparatus 10. Then, the apparatus 10 decrypts the received items and collates them with the information stored in the HDD 10d to verify whether the received password is correct. If the password is correct, the transaction supporting apparatus 10 sends a screen 80 shown in FIG. 14 to the buyer client 14. This notifies the buyer of completion of the intermediary service process by the transaction supporting apparatus 10.

The process following the above is the same as that executed at the time of the first transaction except the authentication procedure by the home-delivery service agent.

As described above, in each transaction after the first transaction via the transaction supporting apparatus 10, the buyer can promptly order products to a seller who cooperates with the apparatus 10 by merely entering his or her own membership number and password. This avoids a risk of repetitive entry of important individual information such as the card number. Even if the membership number or the like leaks, a person who gets the individual information will not be able to utilize it to promote his or her own benefit because the delivery destination is limited to the place on the map shown in FIG. 10. Also, the payment of the purchased products is remitted to the specified bank account, which avoids expensive service fees that are charged when the credit card is used.

The seller can sell products on the security of credit cards and avoid a situation such that the debits cannot be collected.

There is no need to include a card commission in the price of products. This would reduce the sale prices. Even startup companies, which are generally not allowed to make registration in card companies, can utilize convenience of settlement using credit cards.

In the above embodiment of the invention, the payment is made to the bank account even when the transaction supporting apparatus 10 is utilized for the first time. Alternatively, the payment of the products may be made in cash to the home-delivery service agent. This alternative simultaneously enables both authentication and payment and facilitates convenience of the buyer.

In the membership registration of the embodiment, the buyer enters his or her address on the screen 50 shown in FIG. 7 as character information. Alternatively, a map may be displayed on the screen as in the case of FIG. 10, on which map the buyer points to his or her address. A person attempts to illegally use address information that is entered this way will have to get obtain information about both map information and information about the location on the map. This would reduce the probability of leakage of information. Also, the way to entry the address on the map would be advantageous to the home-delivery service agent because it facilitates identifying the location of the delivery destination more specifically.

In the above embodiment, payment of the purchased products is made to the seller'account. In an alternative, money may be automatically transferred from the buyer's account to the specified bank account. This would avoid a troublesome situation such that the buyer goes to the bank. Automatic transfer from the buyer's account into the specified account is required to notify the transaction supporting apparatus 10 of information about the bank account in advance. This may be accomplished in such a manner that the buyer enters the name of his or her bank account on the screen 50 shown in FIG. 7 or notifies the home-delivery service agent of the bank account.

The settlement by the credit card can be made to automatically remit payment from the buyer's bank account to the specified bank account. In this case, the buyer is required to open an account for settlement by the credit card in advance. The home-delivery service agent may guide and help the buyer to open an account.

In the foregoing, payment is made by remittance to the bank account. Alternatively, other means for making payment to the buyer or the intermediary agent through a convenience store, a postal office or a registered cash mail.

In the foregoing embodiment, in the case where an intermediary agent is chosen and the buyer does not have the membership, the card number and the other items are not registered on the screen 50 shown in FIG. 5 but are registered at the time of delivery in the first transaction. However, the card number may be registered on the screen 50 in addition to the other items. In this alternative, information about the buyer registered in connection with his or her credit card can immediately be utilized. That is, information stored in the server 7 of the credit card company can be utilized.

In another embodiment of the present invention, only the address registered in the credit card is used as the delivery destination. The transaction supporting apparatus 10 cooperates with the server 7 (FIG. 1) of the credit card company, and compares the address registered therein with that registered in the apparatus 10. If the credit card number is not entered on the screen 50 shown in FIG. 7, entry of the card number is made at the time of delivery in the first transaction. If the address registered in the credit card does not coincide with that at the time of delivery, intermediary service may be stopped. The intermediary service may also be stopped if the address input on the screen 50 shown in FIG. 7 does not coincide with the address registered in the credit card. A map including the location specified by the address registered in the credit card is displayed when the buyer places an order for purchasing. This is accomplished by using map software recorded on a DVD (Digital Video Disk) that has come into wide use. A map including the location specified by the address is displayed when the buyer places an order. The correct location or more detailed location may be specified on a Web site.

In yet another embodiment of the present invention, the transaction supporting apparatus 10 investigates the credits of both the buyer and seller by using their names and e-mail addresses, and notifies the results of investigation of the buyer and seller via e-mails. This may be performed before or after the step of FIG. 4. The credit of the buyer may be checked by investigation conducted by the credit card company or information registered in the server 7 thereof. The investigation conducted by the credit card company may also be utilized to check the credit of the seller. Further, the transaction supporting apparatus 10 may cooperate with another investigation agency although it is not illustrated in FIG. 1. In this case, the transaction supporting apparatus 10 utilizes information stored in a server of the investigation agency in addition to the network 5.

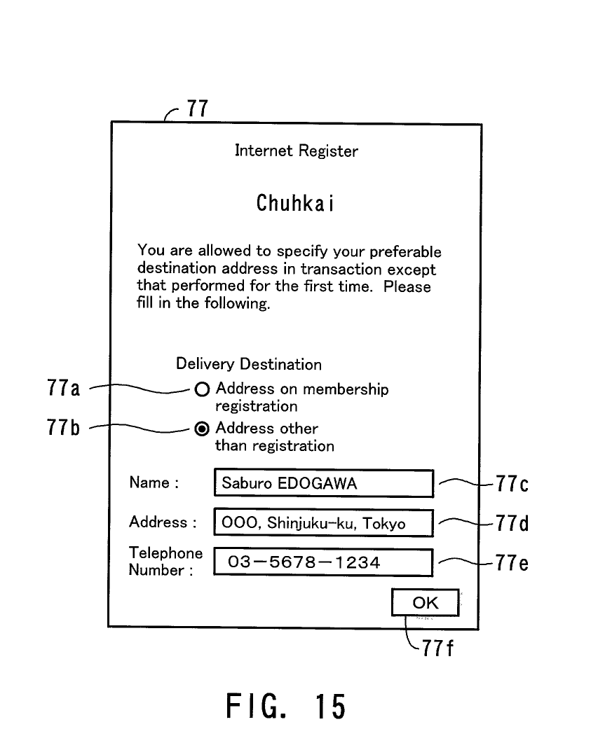

The delivery destination is specified by only the address registered in the credit card or membership registration. When a person having the membership has performed a transaction at least once, this person would gain credit with the intermediary agent. Therefore, purchased products may be delivered to a place which the buyer would like in each transaction after the first transaction. In this case, as shown in FIG. 15, information about the address of a delivery destination and other necessary items are entered on a screen 77. In the example of FIG. 15, the user can choose the registered address of the membership or any preferred address. When the latter is chosen, the purchased products are delivered to the destination specified by the items of information that are entered to text boxes 77c through 77e.

The foregoing description is directed to the cooperation of remittance to the specified account and the substitute way to make payment via the credit card because of failure of settlement. The intermediary service is available even in a case where the buyer uses his or her credit card from the first transaction.

A description will now be given of flowcharts describing program that causes the transaction supporting apparatus 10 to implement the above-mentioned functions.

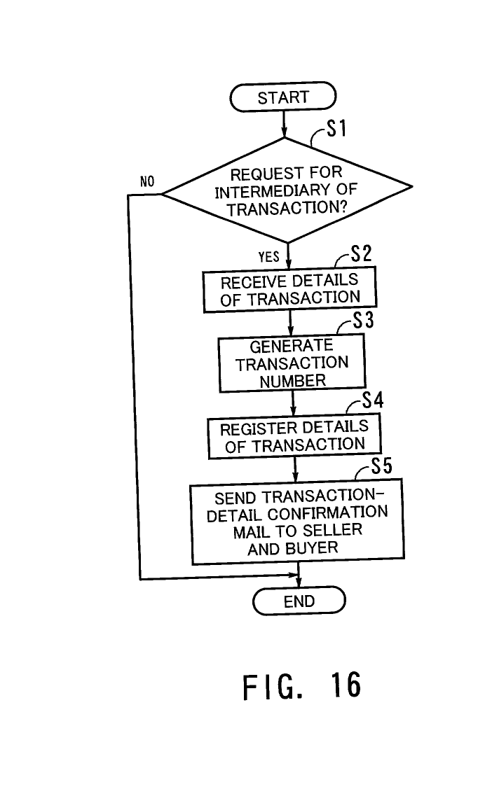

FIG. 16 is a flowchart of a process executed by the transaction supporting apparatus 10 when a seller agrees with a transaction and the apparatus 10 is informed of the details of the transaction. The process shown in FIG. 16 starts with step S1.

[S1] The CPU 10a determines whether a request for intermediary service of transaction has been received. If the answer of step S1 is YES, the CPU 10a proceeds to step S2. In contrast, if the answer of step S1 is NO, the CPU 10a ends the process.

[S2] The CPU 10a receives the details of the transaction from the seller server 12 that has requested intermediary service.

[S3] The CPU 10a generates a transaction number that is a unique series of figures or letters.

[S4] The CPU 10a registers the details of the transaction in the HDD 10d in association with the transaction number.

[S5] The CPU 10a sends transaction-detail confirmation mails to ask the buyer and the seller to confirm the details of the transaction. FIG. 4 shows an example of the transaction-detail confirmation mail that is sent to the buyer.

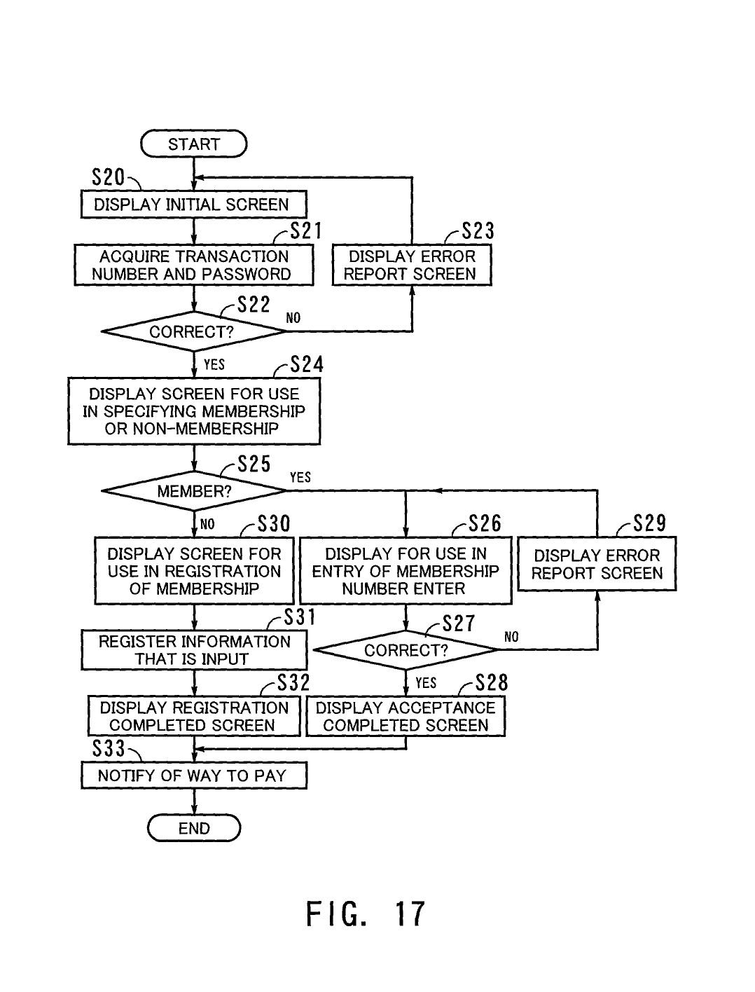

FIG. 17 is a flowchart of a process executed when the buyer clicks a URL (that is used when the details of the transaction received from the transaction supporting apparatus 10 are correct) attached to the transaction-detail confirmation mail. This process starts with step S20.

[S20] The CPU 10a acquires an HTML (Hyper Text Markup Language) document for displaying the initial screen 30 shown in FIG. 5, and sends it to the buyer client 14 that has accessed the transaction supporting apparatus 10.

[S21] The CPU 10a acquires the transaction number and the password sent by the buyer client 14.

[S22] The CPU 10a refers to the information stored in the HDD 10d and verifies whether the received transaction number and the password are correct. If the answer is YES, the CPU 10a proceeds to step S24. If the answer is NO, the CPU 10a proceeds to step S23.

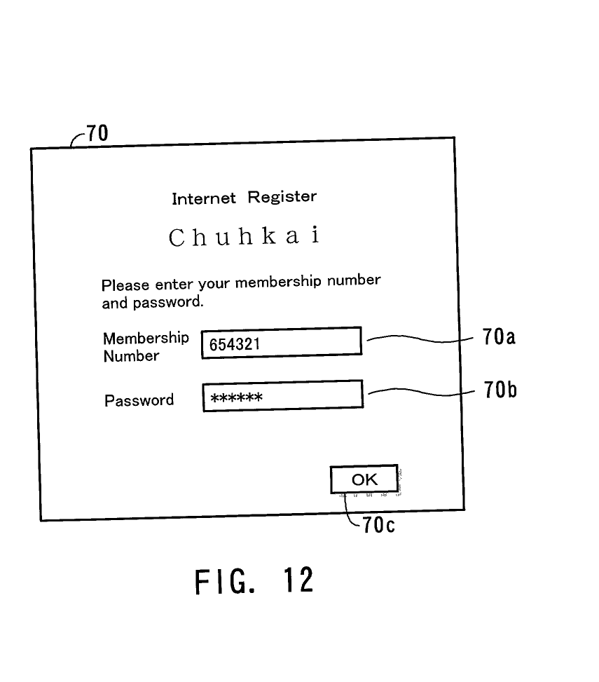

If the answer of step S22 is successively NO a predetermined number of times, the CPU 10a preferably terminates the process in order to prevent the CPU 10a from falling in an infinite loop.

[S23] The CPU 10a sends data for forming an error reporting screen to the buyer client 14 if the transaction number or the password is not correct. The error reporting screen displayed at the buyer client 14 notifies the buyer client 14 that the transaction number or the password that has been entered is not correct.

[S24] The CPU 10a sends to the buyer client data for forming the screen 40 (see FIG. 6) for asking the buyer to specify a category into the membership or non-membership.

[S25] The CPU 10a refers to the received information to determine whether the buyer client 14 has the membership. The CPU 10a proceeds to step S26 if the answer of this step is YES and to step S30 if the answer is NO.

[S26] The CPU 10a sends to the buyer client 14 data for forming the screen 70 (see FIG. 12) for asking the buyer to enter the membership number and the password. The screen 70 is displayed at the buyer client 14.

[S27] The CPU 10a verifies whether the received membership number and password are correct. The CPU 10a proceeds to step S28 if the answer is YES and to step S29 if the answer is NO.

If the answer is successively NO a predetermined number of times, the CPU 10a ends the process in order to prevent the CPU 10a from falling in an infinite loop.

[S28] The CPU 10a sends to the buyer client 14 data forming the screen 80 (see FIG. 14) that shows completion of the acceptance process. The screen 80 is displayed at the buyer client 14.

[S29] The CPU 10a sends to the buyer client 14 the error reporting screen which notifies the buyer client 14 that the membership number or the password that has been input is incorrect.

[S30] The CPU 10a sends to the buyer client 14 data for forming the screen 50 (see FIG. 7) for use in making the membership registration.

[S31] The CPU 10a receives information that has been entered on the membership registration screen 50 and registers the information in a given area of the HDD 10d.

[S32] The CPU 10a sends to the buyer client 14 data for forming the screen 60 (see FIG. 8) showing that the membership registration has been made.

[S33] The CPU 10a creates an e-mail that describes the account to which payment should be made and the deadline for payment, and sends the e-mail to the buyer client 14.

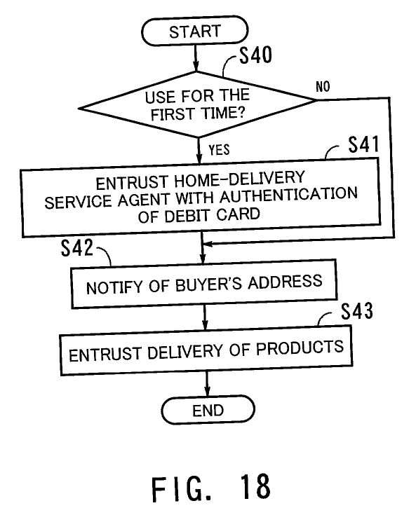

FIG. 18 is a flowchart of a process executed when the transaction supporting apparatus 10 requests the server 13 of the home-delivery service agent to deliver products. The process starts with step S40.

[S40] The CPU 19a determines whether the transaction of interest has been performed for the first time by the buyer. If the answer of this step is YES, the CPU 10a proceeds to step S41. If the answer is NO, the CPU 10a proceeds to step S42.

[S41] The CPU 10a sends to the server 13 of the homedelivery service agent data for entrusting authentication of the credit card to the home-delivery service agent.

[S42] The CPU 10a notifies the server 13 of the homedelivery service agent of the address of the buyer by location information on the map or character information.

[S43] The CPU 10a sends to the server 13 of the homedelivery service agent given data for entrusting delivery of products thereto.

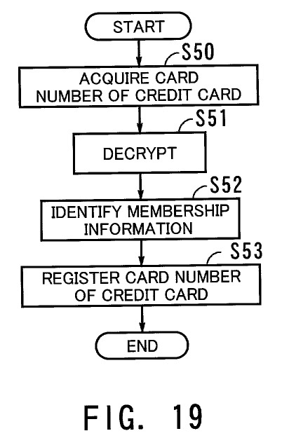

FIG. 19 is a flowchart of a process executed when the card number of the credit card is forwarded from the terminal equipment of a person in charge of delivery via the server 13 of the home-delivery service agent. The process starts with step S50.

[S50] The CPU 10a acquires the card number of the credit card which has been encrypted by the terminal equipment of the delivery person.

[S51] The CPU 10a decrypts the encrypted card number.

[S52] The CPU 10a searches the HDD 10d to acquire the individual membership information corresponding to the card number.

[S53] The CPU 10a registers the number of the credit card.

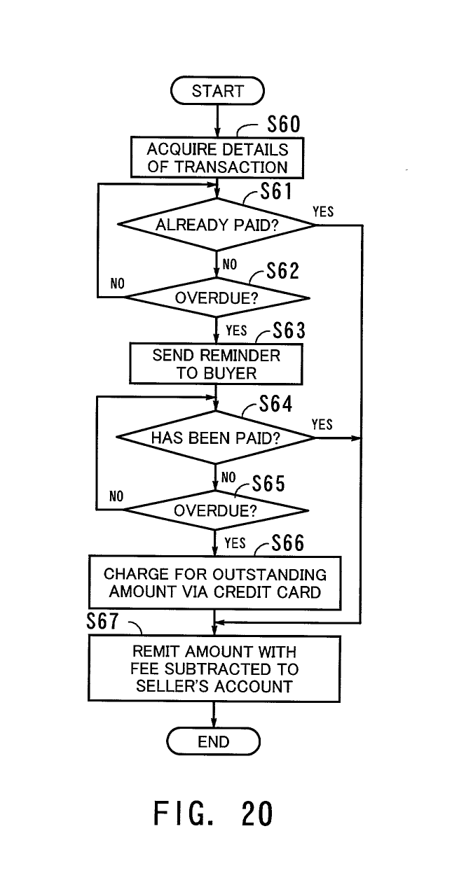

FIG. 20 is a flowchart of a process executed when the transaction supporting apparatus 10 confirms the payment of the price of the products made by the buyer. The process starts with step S60.

[S60] The CPU 10a acquires the details of the related transaction stored in the HDD 10d.

[S61] The CPU 10a accesses the bank server 15 and determines whether the amount indicated in the details of the transaction has been paid. The CPU 10a proceeds to step S67 if the answer of this step is YES and to step S62 if the answer is NO.

[S62] The CPU 10a refers to the deadline for payment described in the details of the transaction and determines whether the outstanding payment is overdue. If the answer of this step is YES, the CPU 10a proceeds to step S63. If not, the CPU 10a returns to step S61 and repeats the same process.

[S63] The CPU 10a sends a reminder (see FIG. 11) to the buyer.

[S64] The CPU 10a has access to the bank server 15 and determines whether the amount indicated in the details of the transaction has been paid. If the answer of this step is YES, the CPU 10a proceeds to step S67. In contrast, if the answer is NO, the CPU 10a proceeds to step S65.

[S65] The CPU 10a refers to the deadline for payment described in the details of the transaction (that is the new deadline updated at step S63), and determines whether the outstanding payment is overdue. If the answer of this step is YES, the CPU 10a proceeds to step S66. If the answer is NO, the CPU 10a returns to step S64 and repeats the same process.

[S66] The CPU 10a accesses the server 16 of the credit card company and charges for the amount in the name of the buyer.

[S67] The CPU 10a accesses to the bank server 15, and remits the amount from which a service charge has been subtracted to the seller's account.

The above-mentioned processes implement the functions of the embodiment of the present invention that has been described with reference to FIG. 2.

The functions of the embodiment of the present invention can be implemented by a computer. In this case, the functions of the transaction supporting apparatus 10 are described in a program recorded in a computer-readable recording medium. The computer executes this program to implement the transaction supporting apparatus 10. Typical examples of the computer-readable recording medium are a magnetic recording device and a semiconductor memory. The programs may be stored in a portable recording medium such as a CD-ROM (Compact Disk Read Only Memory) or a floppy disk, which is easily available in the market. It is also possible to store the program in a storage device of a computer connected to a network and to transfer it to another computer through the network. When the computer executes the program, it is read out from a hard disk drive or the like built in or externally connected to the computer and is loaded to the main memory.

As described above, the transaction supporting apparatus according to an aspect of the present invention receives the details of a transaction from a server of a seller and stores it therein. The apparatus sends to a buyer information indicating an account to which payment of the transaction should be made and a deadline for this payment. If payment has not been made by the deadline, the transaction supporting apparatus charges for the unsettled transaction via a credit card. Therefore, the buyer can make payment upon receiving a purchased product, and the seller mortgages the credit card. Thus, transactions can be performed with security.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A transaction supporting apparatus supporting making payment of a transaction comprising:
transaction-detail registering means for registering details of a transaction;
payment information notifying means for notifying a buyer of payment information;
payment confirming means for confirming whether payment of the transaction has been made to an account specified in the payment information by a deadline also specified in the payment information; and
charging means for charging for the transaction via a credit card when said payment confirming means confirms that the payment has not been made by the deadline.

2. The transaction supporting apparatus according to claim 1, further comprising means for sending to the buyer a reminder message which reminds the buyer of payment when the payment confirming means confirms that payment has not been made by the deadline,
said charging means charges for the transaction via the credit card when a given period described in the reminder message has expired.

3. The transaction supporting apparatus according to claim 1, further comprising means for remitting to the seller an amount obtained by subtracting a given service fee from an amount paid by the buyer.

4. The transaction supporting apparatus according to claim 1, further comprising means for inputting card information necessary to charge for the transaction via the credit card,
said card information being information that a delivery service agent who delivers a product to the buyer directly obtains from the buyer at the time of a first transaction by the buyer.

5. The transaction supporting apparatus according to claim 1, further comprising means for making a transfer into an account of the buyer,
said charging means charges for the transaction via the credit card if said payment confirming means confirms that said account of the buyer does not have a balance sufficient to the payment to be made by the buyer.

6. The transaction supporting apparatus according to claim 1, further comprising means for requesting a home-delivery service agent to deliver a product purchased by the buyer and notifying the home-delivery service agent of information about the buyer, said information about the buyer including an address of a delivery destination.

7. A method of supporting making payment of a transaction comprising the steps of:
registering details of a transaction;
notifying a buyer of payment information;
confirming whether payment of the transaction has been made to an account specified in the payment information by a deadline also specified in the payment information; and
charging for the transaction via a credit card when it is confirmed that the payment has not been made by the deadline.

8. A computer-readable recording medium storing a program that causes a computer to function as:
transaction-detail registering means for registering details of a transaction;
payment information notifying means for notifying a buyer of payment information;
payment confirming means for confirming whether payment of the transaction has been made to an account specified in the payment information by a deadline also specified in the payment information; and
charging means for charging for the transaction via a credit card when said payment confirming means confirms that the payment has not been made by the deadline.
